(19) United States
(12) Patent Application Publication
(10) Pub. No.: US 2008/0164238 A1
(43) Pub. Date: Jul. 10, 2008

(54) Method of etching a metal oxide layer

(75) Inventors: Seok-jae Chung, Seongnam-si (KR); Soon-won Hwang, Seoul (KR); Jung-hyun Lee, Yongin-si (KR); Yeon-hee Kim, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/987,738

(22) Filed: Dec. 4, 2007

(30) Foreign Application Priority Data
Jan. 5, 2007 (KR) 10-2007-0001702

(51) Int. Cl. B44C 1/22

(52) U.S. Cl. 216/67

(57) ABSTRACT

A method of etching a metal oxide layer formed on a metal layer is provided. The method includes mounting a specimen having the metal oxide layer and a photoresist on the metal oxide layer in a reaction chamber, wherein the metal oxide layer is formed on the metal layer and a pattern is formed on the photoresist. Primary etching of the metal oxide layer exposed by the photoresist may be performed using Cl₂ gas in an inductively coupled plasma method. Secondary etching of residues remaining on an etched region of the metal oxide layer may be performed using BCl₃ gas in the inductively coupled plasma method.

### PRIORITY STATEMENT

This application claims the benefit of priority under 35 U.S.C. §119 from Korean Patent Application No. 10-2007-0001702, filed on Jan. 5, 2007, in the Korean Intellectual Property Office, the disclosure of which is incorporated herein in its entirety by reference.

### BACKGROUND

1. Field

Example embodiments relate to a method of etching a metal oxide. Other example embodiments relate to a method of etching a metal oxide layer formed on a metal layer without forming residues of the metal oxide layer.

2. Description of the Related Art

Semiconductor elements may be manufactured using various techniques including deposition and etching methods. Conventional methods of forming an oxide layer on an electrode and etching the oxide layer may be performed during the manufacture of a semiconductor capacitor or a resistive memory device. As research has been conducted on a resistive memory device having a transition metal oxide layer formed on a noble metal electrode, the desirability of a method for etching the transition metal oxide layer formed on the noble metal electrode has increased.

As well known in the art, a metal thin film may not be easily etched. For a metal oxide thin film, etching may be difficult to perform due to a substantially low reactivity of the metal oxide thin film with an etching gas. Conventionally, an ion milling process, in which an ion beam of argon (Ar) gas is irradiated onto a desired material, may be performed. The ion milling process forms a by-product that is formed by re-depositing particles of an etched material on a side of the metal oxide thin film after performing the ion milling process. The by-product causes the metal oxide thin film to be undercut due to excessive etching of the metal oxide thin film to an unwanted (or undesirable) depth. The by-products may damage the metal oxide thin film due to an unclean lateral etching shape.

Recently, etching a metal oxide layer formed on a metal electrode has been attempted using reactive ion etching (RIE). It may be difficult to generate etching resides that are volatile in order to avoid forming residues on the metal electrode. In order to avoid the formation of residue on the metal electrode, the etching must be performed at a temperature of approximately 300° C. or higher. Such high temperatures may cause a thermal damage to the remaining portions of the metal thin film and/or to a semiconductor device that includes the metal thin film.

FIGS. 1A through 1C are diagrams illustrating cross-sectional views of a conventional etching method of a metal oxide layer formed on a metal electrode.

Referring to FIG. 1A, the metal oxide layer 12, which is formed of a metal (e.g., NiO), may be formed on the metal electrode 11 formed of a noble metal (e.g., Pt). After forming a photoresist 13 on the metal oxide layer 12, the exposed region of the metal oxide layer 12, on which the photoresist 13 is not formed, may be etched using a dry etching process (e.g., RIE).

Referring to FIG. 1B, the exposed region of the metal oxide layer 12, which the photoresist 13 is not formed, may be etched. As such, portions of the metal electrode 11 may be exposed. Residues 14, which may form due to the combining (or bonding) of oxygen atoms O from the exposed region of the metal oxide layer 12 with the material of the metal electrode 11, may remain on the metal electrode 11. In order to remove the residues 14 from the metal electrode 11, an O₂ ashing process may be performed. It may be difficult to completely remove the residues 14 using the O₂ ashing process.

Referring to FIG. 1C, if the metal oxide layer 12 is formed on the metal electrode 11, a mixed layer 15 may form due to an intermixing between the metal electrode 11 and the metal oxide layer 12. For example, if the metal electrode 11 is formed of platinum (Pt) and the metal oxide layer 12 is formed of nickel oxide (NiO), the mixed layer 15 may be formed including a mixed material (e.g., NiO and Pt). The residues 14, as shown in FIG. 1B, may include the mixed material of the mixed layer 15. If the RIE process is performed at a temperature of approximately 300° C. or more, the formation of the mixed layer 15 and/or degradation of the semiconductor device may increase.

### SUMMARY

Example embodiments relate to a method of etching a metal oxide. Other example embodiments relate to a method of etching a metal oxide layer formed on a metal layer without forming residues of the metal oxide layer.

Example embodiments provide a method of etching a metal oxide formed on a metal layer by which a clean lateral and cross-section may be obtained at a substantially low temperature.

According to example embodiments, there is provided a method of etching a metal oxide layer formed on a metal layer including mounting (or placing) a specimen in a reaction chamber, wherein the specimen includes the metal oxide layer and a photoresist; primary etching the metal oxide layer exposed by the photoresist using chlorine (Cl₂) gas in an inductively coupled plasma method and secondary etching residues remaining on an etched region of the metal oxide layer using boron trichloride (BCl₃) gas in the inductively coupled plasma method. A pattern may be formed on the photoresist.

The metal layer may be formed of a noble metal (e.g., platinum (Pt), rhodium (Rh), gold (Au), tantalum (Ta) and combinations thereof). The metal oxide layer may be formed of an oxide (e.g., nickel oxide (NiO), copper oxide (CuO), niobium oxide (NbO), titanium oxide (TiO), zirconium oxide (ZrO), zinc oxide (ZnO), iridium oxide (IrO) and combinations thereof).

The primary and secondary etchings may be performed at a temperature of 0° C. to 100° C., or about 0° C. to 100° C.

A partial pressure of the Cl₂ gas in the primary etching method may be 40% to 70%, or about 40% to 70%, of the total pressure. A partial pressure of the BCl₃ gas in the secondary etching method may be 40% to 70%, or about 40% to 70%, of the total pressure.

### BRIEF DESCRIPTION OF THE DRAWINGS

Example embodiments will be more clearly understood from the following detailed description taken in conjunction with the accompanying drawings. FIGS. 1-5 represent non-limiting, example embodiments as described herein.

FIGS. 1A through 1C are diagrams illustrating cross-sectional views of a conventional etching method of a metal oxide layer formed on a metal electrode;

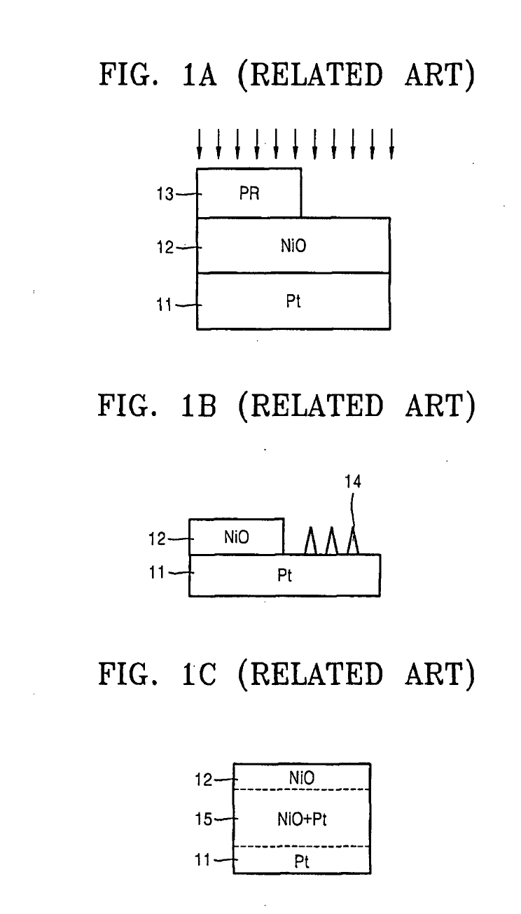

FIGS. 2A through 2C are diagrams illustrating cross-sectional views of a method of etching a metal oxide layer formed on an electrode according to example embodiments;

FIGS. 3A and 3B are scanning electron microscope (SEM) images of a surface of the specimen of FIG. 2B after a primary etching process has been performed according to example embodiments;

FIGS. 4A and 4B are scanning electron microscope (SEM) images of a surface of the specimen of FIG. 2C after a secondary etching process has been performed according to example embodiments; and

FIG. 5 is a diagram illustrating a cross-sectional view of an inductively coupled plasma process chamber.

### DETAILED DESCRIPTION OF EXAMPLE EMBODIMENTS

Various example embodiments will now be described more fully with reference to the accompanying drawings in which some example embodiments are shown. In the drawings, the thicknesses of layers and regions may be exaggerated for clarity.

Detailed illustrative embodiments are disclosed herein. However, specific structural and functional details disclosed herein are merely representative for purposes of describing example embodiments. This invention may, however, may be embodied in many alternate forms and should not be construed as limited to only example embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the scope of example embodiments.

Spatially relative terms, such as “beneath,” “below,” “lower,” “above,” “upper” and the like, may be used herein for ease of description to describe one element or a relationship between a feature and another element or feature as illustrated in the figures. It will be understood that the spatially relative terms are intended to encompass different orientations of the device in use or operation in addition to the orientation depicted in the Figures. For example, if the device in the figures is turned over, elements described as “below” or “beneath” other elements or features would then be oriented “above” the other elements or features. Thus, for example, the term “below” can encompass both an orientation which is above as well as below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

In order to more specifically describe example embodiments, various aspects will be described in detail with reference to the attached drawings. However, the present invention is not limited to example embodiments described.

Example embodiments relate to a method of etching a metal oxide. Other example embodiments relate to a method of etching a metal oxide layer formed on a metal layer without forming residues of the metal oxide layer.

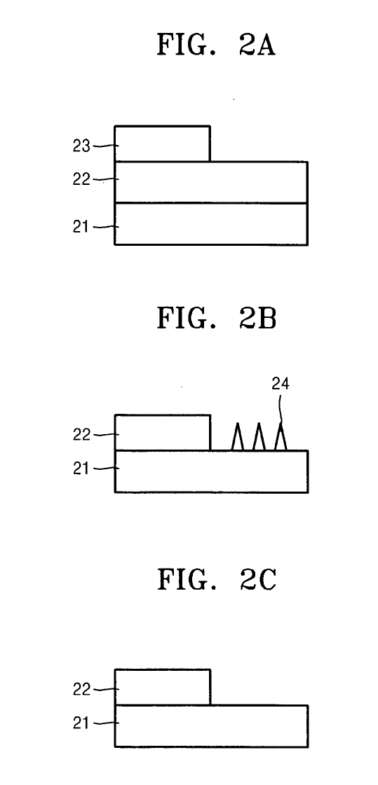

FIGS. 2A through 2C are diagrams illustrating cross-sectional views of a method of etching a metal oxide layer 22 formed on an electrode 21 according to example embodiments. Characteristics of example embodiments may include a method of etching the metal oxide layer 22 formed on the electrode 21 using an inductively coupled plasma method.

Referring to FIG. 2A, the metal oxide layer 22 may be formed on the electrode 21 formed of a metal. A photoresist 23 that functions as a mask may be formed on the metal oxide layer 22. The photoresist 23 may be used to form a desired pattern on the metal oxide layer 22. The electrode 21 may be formed of a noble metal (e.g., platinum (Pt), rhodium (Rh), gold (Au), tantalum (Ta) and combinations thereof. The metal oxide layer 22 may be formed of an oxide (e.g., nickel oxide (NiO), copper oxide (CuO), niobium (NbO), titanium oxide (TiO), zirconium oxide (ZrO), zinc oxide (ZnO), cobalt oxide (CoO), iridium oxide (IrO)).

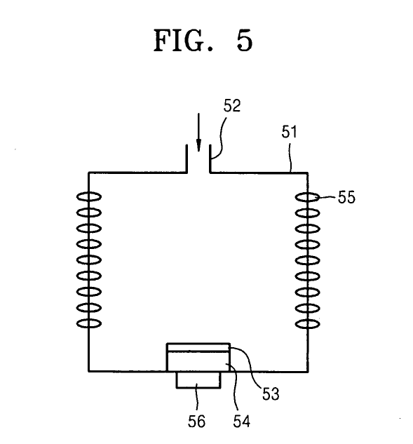

FIG. 5 is a diagram illustrating a cross-sectional view of an inductively coupled plasma process chamber 51 according to example embodiments. A specimen 53 formed as described above may be mounted on a substrate mounting unit 54 in the inductively coupled plasma process chamber 51. Atmosphere gases (e.g., chlorine (Cl₂) and argon (Ar)) may be supplied to the inductively coupled plasma process chamber 51 through a gas supplying unit 52 to generate (or form) plasma for etching. Plasma may be generated in the inductively coupled plasma process chamber 51 by applying a voltage through a main power 55 while controlling a pressure in the inductively coupled plasma process chamber 51.

Referring to FIGS. 2B and 5, an exposed portion of the metal oxide layer 22 may be etched by a primary etching process performed under an atmosphere of a combination of gases (e.g., Cl₂ and Ar). Plasma may be generated under a Cl₂ partial pressure of 40% to 70%, or about 40% to 70%. After plasma has been generated, the metal oxide layer 22 may be etched by applying a biased power in a direction towards the specimen 53 through a biased power applying unit 56. Lateral regions of the metal oxide layer 22, which are primarily etched, may form clean vertical cross-sections without re-deposition of an etching by-product. Residues 24 may be formed on an exposed portion of a top surface of the electrode 21 due to the combining (or reaction between) the electrode 21 and the metal oxide layer 22.

Referring to FIGS. 2C and 5, in order to remove the residues 24 from the top surface of the electrode 21, a secondary etching process may be performed. After a gas in the inductively coupled plasma process chamber 51 has been exhausted to the outside, a boron trichloride (BCl₃) gas and/or atmospheric gases may be injected into the inductively coupled plasma process chamber 51. The atmospheric gases may include argon (Ar) and/or nitrogen (N₂). In the secondary etching process, the residues 24 on the top surface of the electrode 21 may be removed under a BCl₃ partial pressure of 40% to 70%, or about 40% to 70%. Plasma may be generated in the inductively coupled plasma process chamber 51 by applying a voltage through the main power 55 while controlling a pressure in the inductively coupled plasma process chamber 51. In the etching method, the partial pressure of the BCl₃ may be appropriately controlled (or monitored) to increase the amount of radicals and/or ion density of the BCl₃ gas. The residues 24 formed on the top surface of the electrode 21 may be removed in a manner that Cl⁻ ions of the BCl₃ gas etch the residues 24 and/or B³⁺ ions of the BCl₃ gas combine with oxygen, which is a component of the residues 24.

According to example embodiments, a method of etching a metal oxide formed on a metal layer may be performed in a low process temperature of 0° C. to 100° C., or about 0° C. to 100° C. The primary and secondary etching processes as described above may be performed at room temperature (e.g., at, or about, 25° C.).

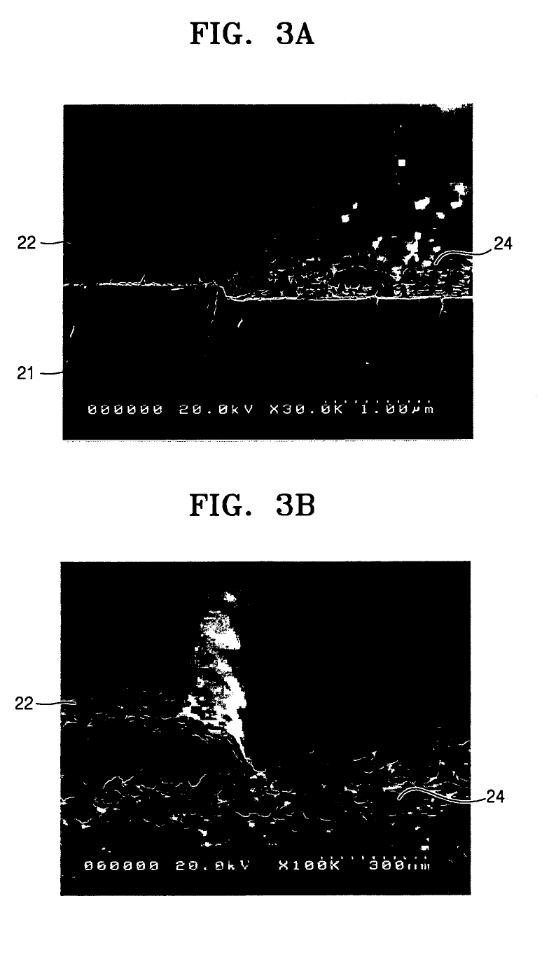

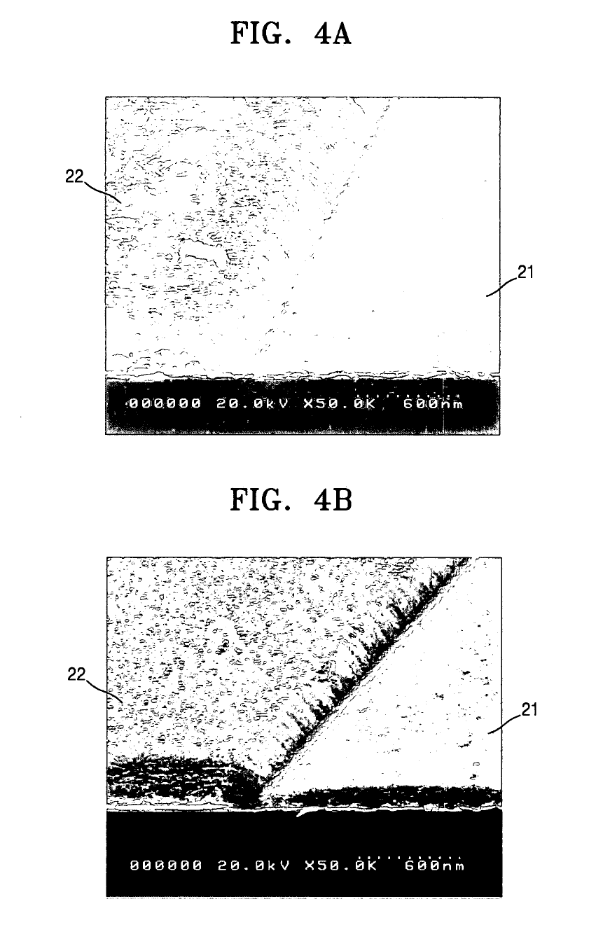

According to example embodiments, the etching method described above may be performed on a specimen of the metal oxide layer 22 formed of NiO and the electrode 21 formed of Pt. Scanning electron microscope (SEM) images of the specimen 53 during etching are shown in FIGS. 3A, 3B, 4A and 4B.

The electrode 21 may be formed on a substrate by depositing (or forming) platinum (Pt) having a thickness of approximately 50 nm. The metal oxide layer 22 may be formed by depositing nickel oxide (NiO) with a thickness of approximately 100 nm on the electrode 21 formed of Pt. The photoresist 23 having a pattern may be formed on the metal oxide layer 22 by performing a lithography method using an i-line stepper as a mask for etching the metal oxide layer 22. After the specimen 53 has been mounted in the inductively coupled plasma process chamber 51, the exposed portion of the metal oxide layer 22 may be etched by generating Cl₂ plasma and performing the primary etching process. The pressure in the inductively coupled plasma method chamber 51 may be 20 mTorr. The applied biased power may be 100 W.

FIGS. 3A and 3B are SEM images showing a surface of the NiO/Pt specimen of FIG. 2B after the primary etching process has been performed.

Referring to FIGS. 3A and 3B, a cross-section of the metal oxide layer 22 was cleanly etched. Protruding residues 24 were formed on the surface of the electrode 21. From a chemical analysis, the residues 24 were formed of an oxide of Pt (e.g., a platinum oxide (PtO)), which is the material used to form the electrode 21.

In order to remove the residues 24 formed of Pt oxides, as depicted in FIG. 2B, the secondary etching process was performed. After supplying BCl₃ gas and atmosphere gases (e.g., a combination of Ar and N₂) in the inductively coupled plasma process chamber 51 and generating plasma, the secondary etching process was performed to remove the residues 24.

FIGS. 4A and 4B are SEM images showing the surface of the NiO/Pt specimen of FIG. 2C after the secondary etching process has been performed.

Referring to FIGS. 4A and 4B, the residues 24 on the electrode 21 were completely (or substantially) removed. As such, a substantially clean surface of the electrode 21 is shown. In order to clean the surface of the electrode 21, the Cl⁻ ions of the BCl₃ gas etch the residues 24 and/or the B³⁺ ions of the BCl₃ gas combine with oxygen. The residues 24 are present in a gas state and may be separated from the electrode 21.

Because the primary and secondary etching processes described above may be performed at, or about, room temperature (i.e., at, or about, 25° C.), the primary and secondary etching processes do not thermally damage the semiconductor device. The metal oxide layer may be removed by the primary etching process that uses the Cl₂ gas. The remaining metal oxide layer having the residues 24 formed on the electrode may be removed by the secondary etching process that uses the BCl₃ gas, forming a substantially clean etch cross-section by decreasing adverse effects to the semiconductor device.

In accordance with a method of etching a metal oxide layer according to example embodiments, residues generated (or formed) during etching of the metal oxide layer formed on a metal electrode may be more effectively removed, obtaining (or forming) a clean etch cross-section.

The etching method may be performed at a relatively low temperature, decreasing thermal damage to a semiconductor device.

The reliability of the semiconductor device may increase by decreasing the residues remaining and/or the thermal damage to the semiconductor device.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages. Accordingly, all such modifications are intended to be included within the scope of this invention as defined in the claims. In the claims, means-plus-function clauses are intended to cover the structures described herein as performing the recited function, and not only structural equivalents but also equivalent structures. Therefore, it is to be understood that the foregoing is illustrative of various example embodiments and is not to be construed as limited to the specific embodiments disclosed, and that modifications to the disclosed embodiments, as well as other embodiments, are intended to be included within the scope of the appended claims.

What is claimed is:

1. A method of etching a metal oxide layer, comprising:
mounting a specimen having the metal oxide layer and a photoresist formed on the metal oxide layer in a reaction chamber, wherein the metal oxide layer is formed on a metal layer and a pattern is formed on the photoresist;
primary etching the metal oxide layer exposed by the photoresist using chlorine (Cl₂) gas in an inductively coupled plasma method; and
secondary etching residues remaining on an etched region of the metal oxide layer using boron chloride (BCl₃) gas in the inductively coupled plasma method.

2. The method of claim 1, wherein a partial pressure of the Cl₂ gas is 40% to 70% of a total pressure.

3. The method of claim 1, wherein a partial pressure of the BCl₃ gas is 40% to 70% of the total pressure.

4. The method of claim 1, wherein the primary and secondary etching are performed simultaneously.

5. The method of claim 1, wherein the primary and secondary etching are performed at a temperature of 0° C. to 100° C.

6. The method of claim 5, wherein the primary and secondary etching are performed at room temperature or about 25° C.

7. The method of claim 5, wherein a partial pressure of the Cl₂ gas is 40% to 70% of a total pressure.

8. The method of claim 5, wherein a partial pressure of the BCl₃ gas is 40% to 70% of the total pressure.

9. The method of claim 1, wherein the metal layer is formed of a noble metal.

10. The method of claim 9, wherein the noble metal is at least one selected from the group consisting of platinum (Pt), rhodium (Rh), gold (Au), tantalum (Ta) and combinations thereof.

11. The method of claim 9, wherein a partial pressure of the Cl₂ gas is 40% to 70% of a total pressure.

12. The method of claim 9, wherein a partial pressure of the BCl₃ gas is 40% to 70% of the total pressure.

13. The method of claim 9, wherein the primary and secondary etching are performed at a temperature of 0° C. to 100° C.

14. The method of claim 13, wherein the primary and secondary etching are performed at room temperature or about 25° C.

15. The method of claim 1, wherein the metal oxide layer is formed of an oxide.

16. The method of claim 15, wherein the oxide is at least one selected from the group consisting of nickel oxide (NiO), copper oxide (CuO), niobium oxide (NbO), titanium oxide (TiO), zirconium oxide (ZrO), zinc oxide (ZnO), cobalt oxide CoO, iridium oxide (IrO) and combinations thereof.

17. The method of claim 15, wherein a partial pressure of the Cl₂ gas is 40% to 70% of a total pressure.

18. The method of claim 15, wherein a partial pressure of the BCl₃ gas is 40% to 70% of the total pressure.

19. The method of claim 15, wherein the primary and secondary etching are performed at a temperature of 0° C. to 100° C.

20. The method of claim 19, wherein the primary and secondary etching are performed at room temperature or about 25° C.
